(19) United States
(12) Patent Application Publication
(10) Pub. No.: US 2011/0103764 A1
(43) Pub. Date: May 5, 2011

(54) BROADCAST CONTENT RECORDING AND REPRODUCING SYSTEM

(75) Inventors: Ryoko MORITA, Osaka (JP); Keita Kobayashi, Osaka (JP); Yoko Matsushima, Osaka (JP); Toshio Sasaoka, Nara (JP)

(73) Assignee: PANASONIC CORPORATION, Osaka (JP)

(21) Appl. No.: 12/985,987

(22) Filed: Jan. 6, 2011

Related U.S. Application Data
(63) Continuation of application No. PCT/JP2009/002939, filed on Jun. 26, 2009.

(30) Foreign Application Priority Data
Jul. 10, 2008 (JP) 2008-180145

(51) Int. Cl. H04N 5/76

(52) U.S. Cl. 386/235; 386/E05.003

(57) ABSTRACT

An input unit receives a viewing condition inputted by a user for a received broadcast content. A reproduction unit reproduces the broadcast content which meets the viewing condition while controlling a reproduction rate indicating a reproduction speed of the broadcast content.

### FIELD OF THE INVENTION

The present invention relates to a recording and reproducing system which helps a user enjoy a broadcast content in a time-efficient manner with less time than an actual recording time in total without breaking continuity of the broadcast content.

### BACKGROUND OF THE INVENTION

In recent years, an increasing number of BS/CS broadcast stations are launched in addition to the existing terrestrial television broadcast stations, and television viewers are now faced with a multichannel age as a result of digitalized broadcasting services. Such a large number of channels available now provide the viewers with a diverse range of broadcast programs, and programs on air are dramatically increasing, leaving the viewers a lot of choices for programs to enjoy.

In the meantime, recording media having such a huge capacity as a few hundred GB or more, which is typified by HDD (hard disc drive), have replaced conventional videotapes, and these recording media are now sold in the market at relatively reasonable prices. As the recording media thus advance, PCs (personal computers) equipped with a function for recording/viewing a broadcast content and recorders equipped with a large-capacity HDD are becoming available. These technical advancements have liberated the viewers from the inconvenience of limited capacities in the conventional recording media. There is no longer need to worry about a recording capacity left in a recording medium when a user records therein whatever the recording target of his choice.

However, the technical advancements raised another inconvenience for users. The increasingly larger capacities of the recording media allow the users to record a heavy volume of broadcast programs, making it difficult for them to keep track of the recorded programs. Some broadcast content viewing support systems were invented to deal with the inconvenience.

For instance, the digital broadcast reception apparatus disclosed in the Patent Document 1 reedits or relocates recorded programs which were replay-programmed with no relevance to their original broadcast hours and divides the programs to fit in a time schedule based on a user's availability before viewing them, thereby helping the user more flexibly enjoy the programs.

### PRIOR ART DOCUMENT

### Patent Document 1: Unexamined Japanese Patent Applications Laid-Open No. 2006-148491

### SUMMARY OF THE INVENTION

### Problem to be Solved by the Invention

The conventional system thus designed to support broadcast viewing have a few problems. As described earlier, the conventional system can reedit or relocate recorded programs which were replay-programmed with no relevance to their original broadcast hours, and divide the programs to fit in a time schedule based on a user's availability before viewing them. Despite the advantage, a total amount of time necessary for the user to view all of the broadcast programs remains unchanged. Therefore, any unviewed programs are accumulated in the recording medium unless the user is available for at least the total recoding time of the recorded programs (available viewing time).

Another problem of the system is to divide the broadcast programs simply by, for example, the number of division or the view time for 1 time of viewing, possibly forcing the user to start or end viewing the broadcast program somewhere in the middle. Thus, continuity of the program content may be lost, and the user might have to replay the part already viewed again, which needs extra time.

The present invention was accomplished to solve these conventional technical problems. The present invention accomplishes such a broadcast content reproduction that a broadcast content of a user's preference can be reproduced in a manner convenient to the user, thereby helping him enjoy a broadcast content in a time-efficient manner with less time than an actual recording time in total without breaking continuity of the broadcast content.

### Means for Solving the Problem

To solve the conventional technical problems, a recording and reproducing system according to the present invention is a system for recording and reproducing a received broadcast content, comprising
an input unit for receiving a viewing condition inputted by a user for the broadcast content; and
a reproduction unit for reproducing the broadcast content which meets the viewing condition received by the input unit while controlling a reproduction rate indicating a reproduction speed of the broadcast content.

### EFFECT OF THE INVENTION

According to the recording and reproducing system provided by the present invention, a broadcast content of a user's choice can be reproduced by a reproduction rate convenient to the user so that any broadcast content can be viewed in a time-efficient manner with less time than an actual recording time in total.

The present invention is further advantageous in that the content division is unnecessary, allowing the user to enjoy the broadcast content without a break in continuity of the content.

### BRIEF DESCRIPTION OF THE DRAWINGS

FIG. 1 is a block diagram illustrating a functional structure of a recording and reproducing system according to the present invention.

FIG. 2 is a block diagram illustrating a structure according to an exemplary embodiment 1 of the present invention.

FIG. 3 is a block diagram illustrating the structure according to the exemplary embodiment 1.

FIG. 4 is a block diagram illustrating the structure according to the exemplary embodiment 1.

FIG. 5 is a block diagram illustrating the structure according to the exemplary embodiment 1.

FIG. 6 is a flow chart of processing steps by the recording and reproducing system according to the present invention.

FIG. 7 is a flow chart of reception processing steps according to the exemplary embodiment 1.

FIG. 8 is a flow chart of analysis processing steps according to the exemplary embodiment 1.

FIG. 9 is a flow chart of viewing condition processing steps according to the exemplary embodiment 1.

FIG. 10 is a flow chart of processing steps for generating a reproduction rate distribution information according to the exemplary embodiment 1.

FIG. 11 illustrates a table in which a time information and reproduction rates of a broadcast content A according to the exemplary embodiment 1.

FIG. 12 is a flow chart of processing steps for generating a list of viewable broadcast contents according to the exemplary embodiment 1.

FIG. 13 illustrates an example of the reproduction rate distribution information according to the exemplary embodiment 1.

FIG. 14 illustrates an example of the list of viewable broadcast contents according to the exemplary embodiment 1.

FIG. 15 illustrates an example of the list of viewable broadcast contents according to the exemplary embodiment 1.

FIG. 16 is a flow chart of reproduction processing steps according to the exemplary embodiment 1.

### EXEMPLARY EMBODIMENTS FOR CARRYING OUT THE INVENTION

### Exemplary Embodiment 1

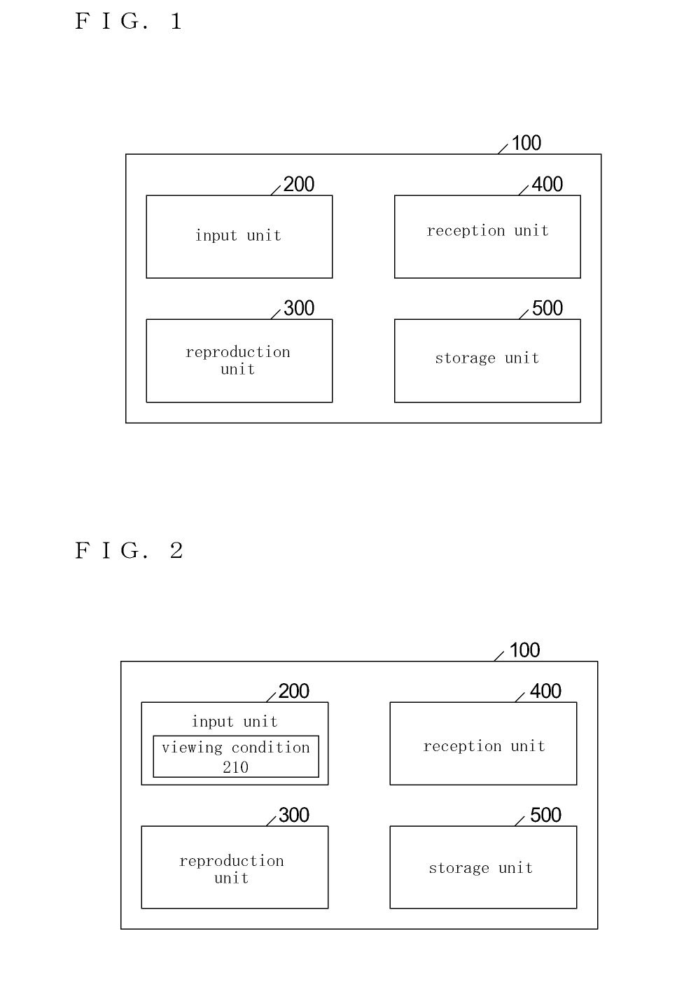

FIG. 1 is a block diagram illustrating a functional structure of a recording and reproducing system according to the present invention. A recording and reproducing system 100 comprises an input unit 200, a reproduction unit 300, a reception unit 400, and a storage unit 500. The reception unit 400 receives a digital broadcast and transmits a broadcast content included in the received digital broadcast to the storage unit 500. The storage unit 500 stores therein the broadcast content transmitted from the reception unit 400. The input unit 200 receives a viewing condition 210 inputted by a user via a man-machine interface, and transmits the received viewing condition 210 to the reproduction unit 300. The reproduction unit 300 reproduces the broadcast content stored in the storage unit 500 while controlling a reproduction rate of the broadcast content depending on the viewing condition 210 transmitted from the input unit 200.

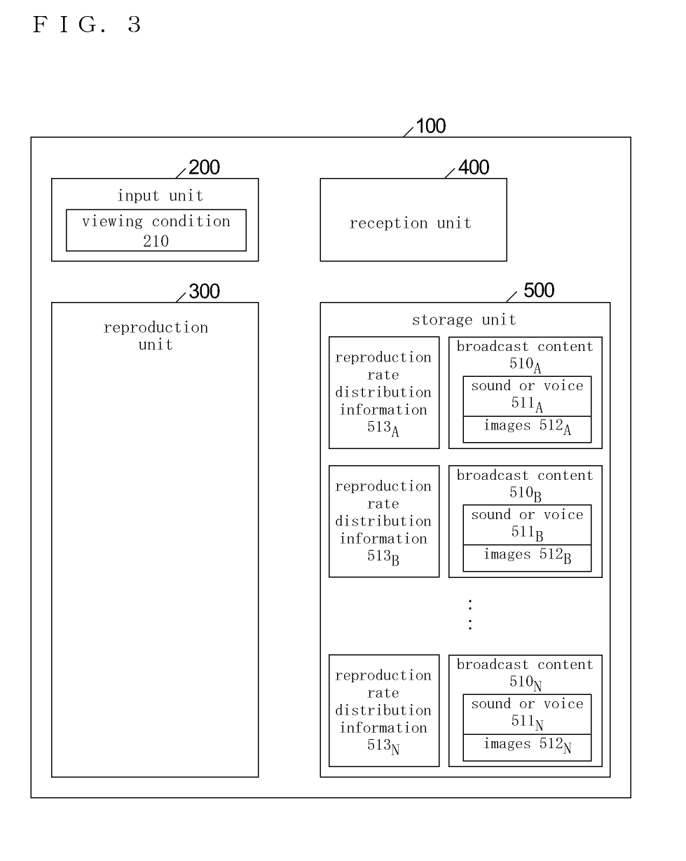

As illustrated in FIG. 2, the input unit 200 is responsible for receiving the viewing condition 210 inputted by the user via the man-machine interface to control the reproduction rate. The input unit 200 transmits the inputted viewing condition 210 to the reproduction unit 300. The viewing condition 210 is a condition which allows or encourages the user to view the broadcast content. The viewing condition 210 may include an amount of viewing time available for the user to view the broadcast content such as 30 minutes or an hour, may include a viewing time point when the user can start viewing the broadcast content such as 9:00 or 20:00, or may include a duration of viewing time when the user is available for viewing the broadcast content such as 9:00-12:00, or two hours from 20:00.

As illustrated in FIG. 3, the reproduction unit 300 reads from the storage unit 500 a group of arbitrary contents (or a single content) among a plurality of broadcast contents 510_{A}-510_{N} depending on the viewing condition 210 transmitted from the input unit 200. Then, the reproduction unit 300 reproduces the read content while controlling a reproduction rate of the content. A reproduction rate (P) represents a reproduction speed when any of the broadcast contents 510_{A}-510_{N} is reproduced by the reproduction unit 300; the content is reproduced at a normal speed when P=1, the content is reproduced at a speed higher than the normal reproduction speed when P>1, and the content is reproduced at a speed lower than the normal reproduction speed when P<1. When P=1.2, for example, the content is reproduced at a speed 1.2 times as high as the normal reproduction speed.

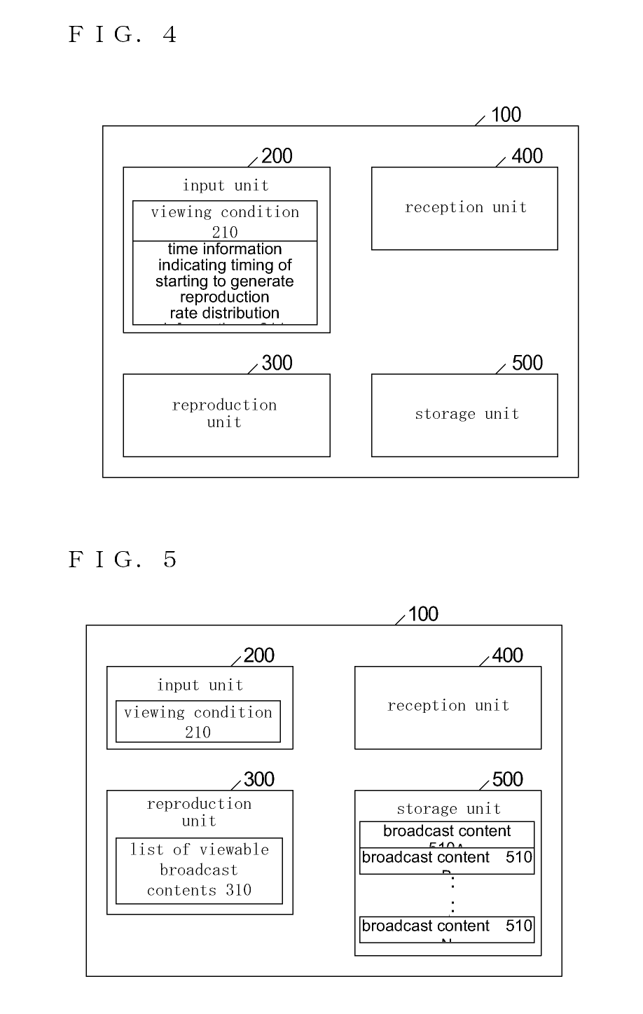

In the reproduction unit 300 is set a time point when a reproduction rate distribution information 513 is generated as illustrated in FIG. 4 based on a time information 211 indicating a timing of starting to generate the reproduction rate distribution information inputted in advance by a user to the input unit 200. As illustrated in FIG. 5, the reproduction unit 300 generates a list of viewable broadcast contents 310 indicating any broadcast contents that can be viewed by the user.

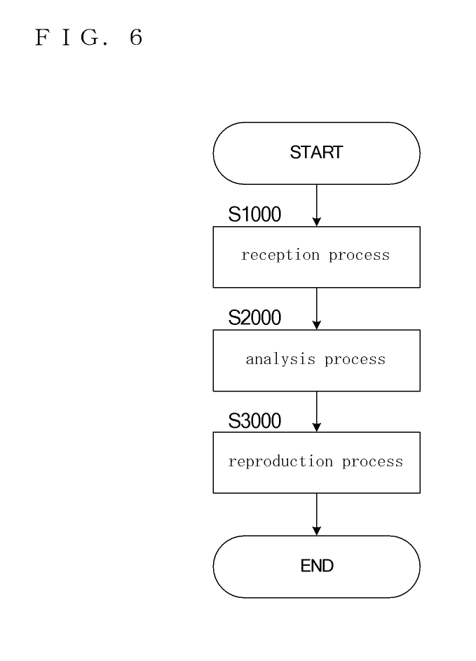

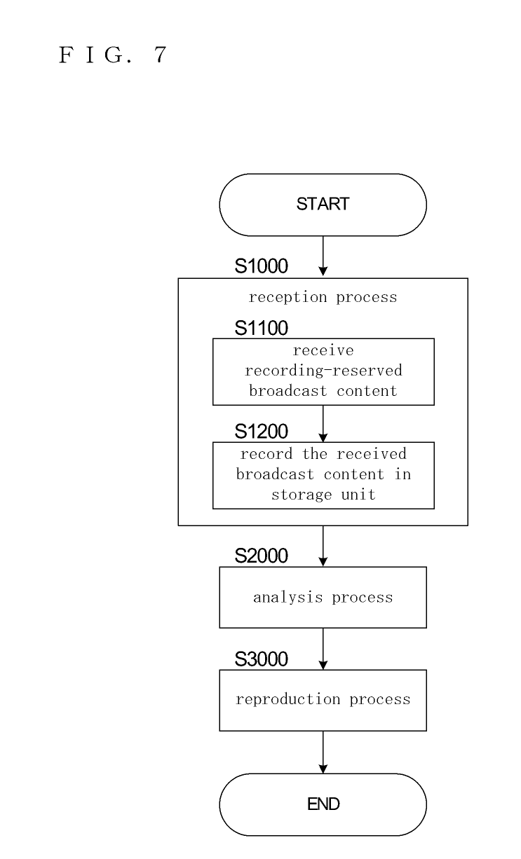

FIG. 6 is a flow chart of processing steps by the recording and reproducing system 100 according to the present invention. In a reception processing (S1000), the system 100 receives a digital broadcast and stores the broadcast contents 510 included in the received digital broadcast in the storage unit 500. In an analysis processing (S2000), the input unit 200 transmits the viewing condition 210 inputted thereto by the user to the reproduction unit 300. In a reproduction processing (S3000), the reproduction unit 300 reproduces any of the broadcast contents 510 which complies with the viewing condition 210. The reproduction unit 300 can control the reproduction rate for the reproduction of any of broadcast contents 510 stored in the storage unit 500. The reproduction unit 300 reproduces the broadcast content 510 while adjusting the production ratio depending on the viewing condition 210.

FIG. 7 is a flow chart specifically illustrating steps of the reception processing (S1000). In the reception processing (S1000), the reception unit 400 receives the broadcast content 510 which is recording-reserved (S1100). Then, the reception unit 400 transmits the received broadcast content 510 to the storage unit 500 so that the content is recorded (S1200).

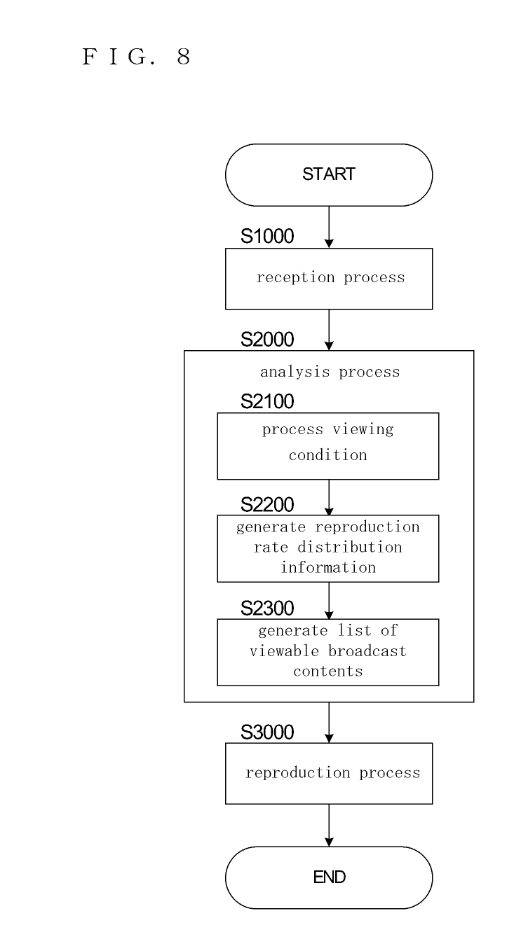

FIG. 8 is a flow chart specifically illustrating steps of the analysis processing (S2000). In the first step of the analysis processing (S2000), the viewing condition 210 inputted to the input unit 200 by the user is processed (S2100). Then, the reproduction rate distribution information 513 is generated (S2200), and the list of viewable broadcast contents 310 is created based on the generated reproduction rate distribution information 513 (S2300).

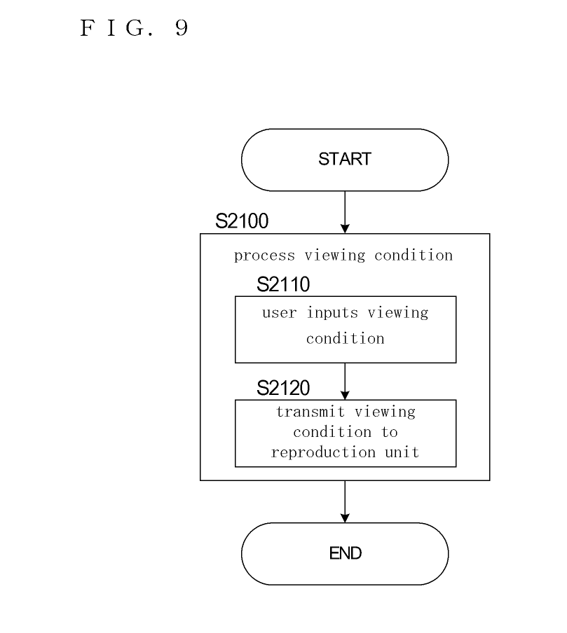

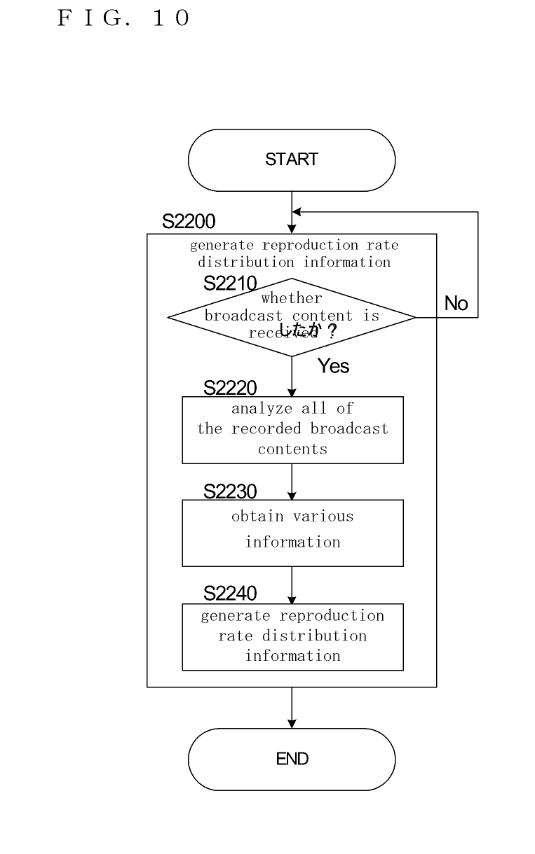

FIG. 9 is a flow chart specifically illustrating steps of processing the viewing condition. The user inputs the viewing condition 210 such as a duration of time available for viewing to the input unit 200 via the man-machine interface (S2110), and the input unit 200 transmits the inputted viewing condition 210 to the reproduction unit 300 (S2120). The viewing condition 210 is a condition for viewing the broadcast content 510 which enables or encourages the user to view the broadcast content 510. The viewing condition 210 may include an amount of viewing time available for the user to view the broadcast content such as 30 minutes or an hour, may include a viewing time point when the user can start viewing the broadcast content such as 9:00 or 20:00, or may include a duration of viewing time when the user is available for viewing the broadcast content such as 9:00-12:00 or two hours from 20:00.

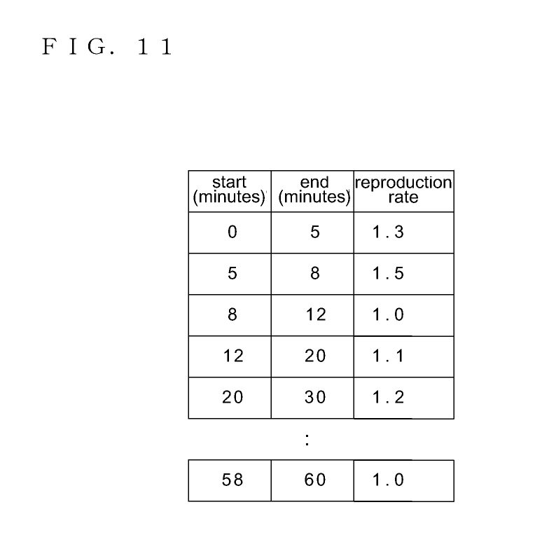

FIG. 10 is a flow chart specifically illustrating steps of generating the reproduction rate distribution information. When the broadcast content 510 received by the reception unit 400 is recorded in the storage unit 500 (Yes in S2210), the reproduction unit 300 analyzes all of the files of the broadcast content 510 (S2220), and obtains various information appended to the broadcast content 510 (S2230). The reproduction unit 510 analyzes the obtained information to calculate the reproduction rate and generates the reproduction rate distribution information 513 (S2240).

In the event that a video information 512 includes subtitle as illustrated in FIG. 3, the viewer can understand the broadcast content 510 when the broadcast content 510 is reproduced faster. Given that a normal reproduction time (NT)=120 (minutes), a subtitle percentage (S) included in the content=70 (%), and a reproduction rate (P) of the subtitle-containing parts=1.5, a required viewing time (CT) after the reproduction rate is converted is, (120×0.7)/1.5+120×(1−0.7)=56+36=92 (minutes). The broadcast content can be viewed in 92 minutes. Thus, the required viewing time to view the broadcast content 510 is reduced by 28 (=120−92) minutes.

In the formula, the reproduction rate (P) of the subtitle-containing parts is 1.5. The reproduction unit 300 may keep track of the history of broadcast contents viewed by each user who uses the recording and reproducing system 100 to calculate and set the reproduction rate which is optimal for each user.

The reproduction unit 300 can obtain the reproduction rate distribution information 513 indicating the reproduction rate distribution on a time axis from information obtained by sampling the broadcast content 510. For example, an interrupt is periodically generated by an operating system (OS), and an information appended to the broadcast content 510 is sampled during the interrupt, so that the sampled information is used to analyze a sound volume distribution of the broadcast content 510. The user can follow any parts of the content where the sound volume is low when the reproduction speed is faster. Therefore, the reproduction unit 300 reproduces the broadcast content 510 at the higher reproduction rate, thereby reducing the required viewing time.

The reproduction unit 300 may obtain information relating to the broadcast content 510 appended thereto and generate the reproduction rate distribution information 513 directly from the obtained information without analyzing the broadcast content 510. In the case where the broadcast content 510 is broadcast by such a broadcast channel that mostly broadcasts, for example, a cultural program where articulate speeches are used, the reproduction rate of the broadcast content 510 can be increased. An example of the information used to determine the details of the broadcast content 510 is BML (Broadcast Markup Language).

A timing of generating the reproduction rate distribution information 513 may be customized by the user. When the user inputs the time information 211 indicating the timing of starting to generate the reproduction rate distribution information to the input unit 200 in advance to set a time point when the reproduction rate distribution information 513 is generated as illustrated in FIG. 4, the time information 211 indicating the timing of starting to generate the reproduction rate distribution information 513 can be generated whenever convenient to the user.

When, for example, the user leaves his home at 9 o'clock, leaving the recording and reproducing system 100 unused while he is out, the user sets 9 o'clock as the time information 211 indicating the timing of starting to generate the reproduction rate distribution information. When the user comes home, the analysis of the reproduction rate distribution information 513 is already completed. Then, the user inputs the viewing condition 210, and he can immediately start viewing the broadcast content 510 which complies with the inputted condition.

It may be omitted to set the timing of generating the reproduction rate distribution information 513. More specifically, a time point when the reception unit 400 receives the broadcast content 510 or a time point when the reproduction unit 300 reproduces the broadcast content 510 is set as the timing of generating the reproduction rate distribution information 513. Then, the user no longer has to pay his attention to the timing of generating the reproduction rate distribution information 513.

The timing of generating the reproduction rate distribution information 513 can be decided by the operational state of an operating system (OS) which controls the recording and reproducing system 100 including the reproduction unit 300. For example, information of a CPU occupancy rate in the OS is checked, and the reproduction rate distribution information 513 is generated when the CPU occupancy rate is low, so that a CPU load is prevented from increasing.

The timing of generating the reproduction rate distribution information 513 may be decided by the state of hardware (H/W) in the recording and reproducing system 100 (operational state of the CPU on which the recording and reproducing system 100 including the reproduction unit 300 is run). When the recording and reproducing system 100 is run by, for example, a CPU which reduces power consumption by suspending the oscillation of an oscillator or a clock generator or suspending clocks to be supplied to the CPU and peripheral circuits, the reproduction rate distribution information 513 is generated by a timing of shifting to a low power mode so that the CPU load can be distributed. To generate the reproduction rate distribution information 513 very late at night or early in the morning when electricity is less expensive is an effective way to reduce electricity costs.

An information of the reproduction rate distribution or the sound volume distribution in the broadcast content 510 on a time axis may be used as the reproduction rate distribution information 513. Then, an information and another information relevant thereto can be tabulated, for example, time information of the broadcast content 510 and its reproduction rate at the time. FIG. 11 shows a table listing the time information and the reproduction rate of a broadcast content 510_{X} which takes 60 minutes to view in the normal reproduction (reproduction rate (P)=1.0). It is read from the given example that the broadcast content 510_{X} can be reproduced at the reproduction rate of 1.3 in five minutes after the reproduction of the broadcast content 510_{X} started (0 minute), and the broadcast content 510_{X} can be reproduced at the reproduction rate of 1.5 in eight minutes since five minutes passed after the start. When the time information and reproduction rate are thus recorded in the form of a table, it becomes unnecessary to create files for the broadcast content 510_{X} after the reproduction rate thereof is converted, thereby avoiding increase of the storage volume for recording on the recording medium.

The required viewing time for viewing the broadcast content 510 at the post-conversion reproduction rate may be used as the reproduction rate distribution information 513. In an example in which a broadcast content 510_{Y} which takes 60 minutes to view in the normal reproduction (reproduction rate (P)=1.0) is reproduced at the post-conversion reproduction rate, and the resulting viewing time of the content is 45 minutes, the reproduction rate distribution information 513 of the content is 45 (minutes).

In the case where the reproduction rate of the broadcast content 510 is converted based on the reproduction rate distribution obtained by analyzing the broadcast content information, files of a broadcast content 510′ after the reproduction rate thereof is converted may be used as the reproduction rate distribution information 513. When the files of the post-conversion broadcast content 510′ are thus created, a processing load of the reproduction unit 300 when the content is reproduced can be alleviated.

In view of a prospective infrastructure which broadcasts a broadcast content 510_{Z} to which the reproduction rate distribution information 513 is already appended, the reproduction rate can be controlled based on the reproduction rate distribution information 513 appended to the broadcast content 510_{Z}. When the advanced infrastructure is accomplished, it is no longer necessary to analyze the broadcast content using the recording and reproducing system 100 to control the reproduction rate of the broadcast content 510_{Z}.

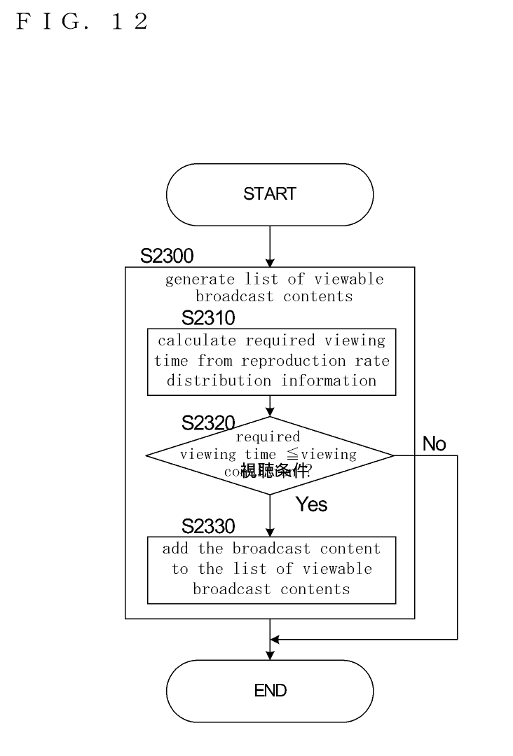

FIG. 12 is a flow chart of processing steps for generating the list of viewable broadcast contents. The reproduction unit 300 searches the broadcast content 510 that can be viewed by the user in the storage unit 500 depending on the viewing condition 210 transmitted from the input unit 200 to generate a list of broadcast contents 510 which meet the viewing condition as the list of viewable broadcast contents 310.

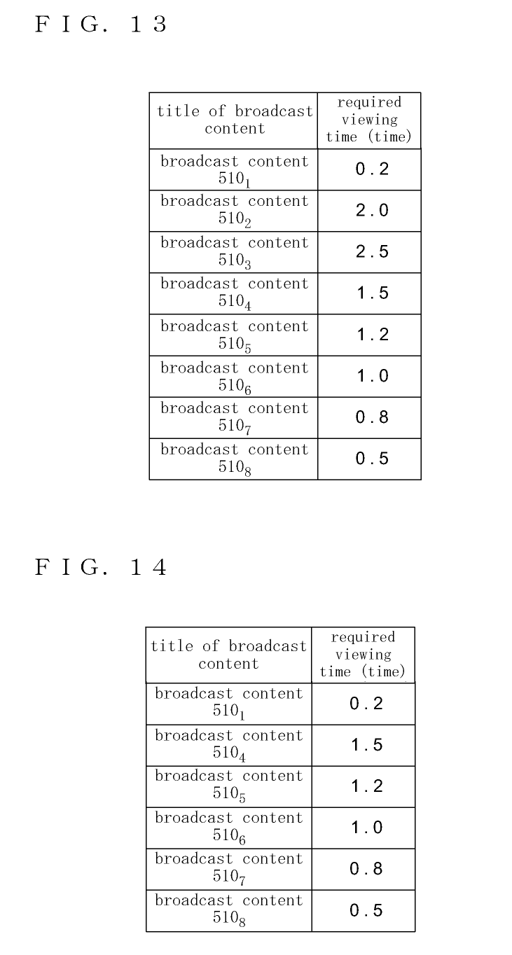

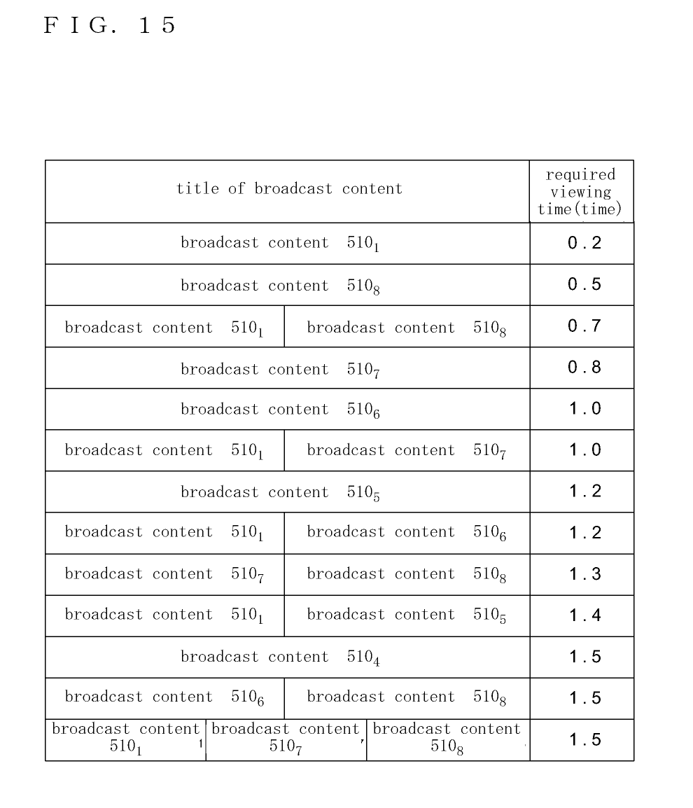

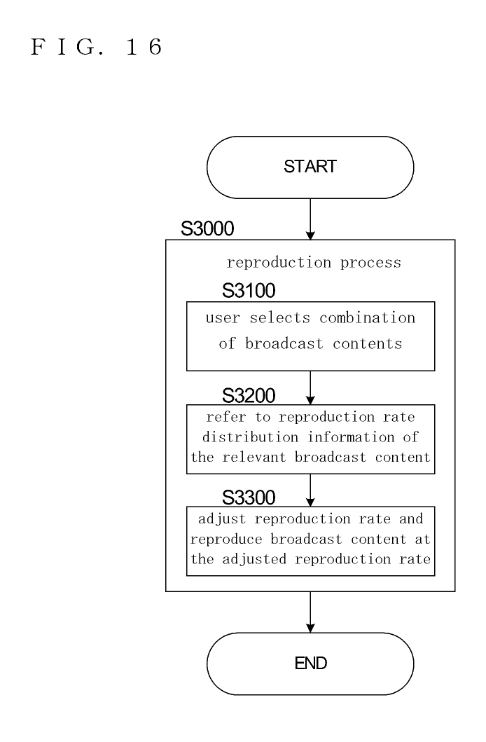

In an example in which 1.5 hours which is an amount of time available for the user (available viewing time) is inputted as the viewing condition 210, and eight broadcast contents 510₁-510₈ already recorded in the storage unit 500 have the reproduction rate distribution information 513 illustrated in FIG. 13, the reproduction unit 300 calculates the required viewing time of each of the broadcast contents 510₁-510₈ from the reproduction rate distribution information 513 of the broadcast contents 510₁-510₈ each (S2310), and adds any of the broadcast contents 510₁-510₈ viewable in 1.5 hours set as the user's viewing condition 210 (Yes in S2320) to the list of viewable broadcast contents 310 (S2330). As a result, the list of viewable broadcast contents 310 illustrated in FIG. 14 can be created. The list of viewable broadcast contents 310 created then may include combinations of the broadcast contents 510₁-510₈ as illustrated in FIG. 15, or sorted in the order of shorter viewing times.

The list of viewable broadcast contents 310 can be created from information of the history of the reproduced broadcast contents 510. For example, the reproduction unit 300 manages the types, hours, reproduction rates, viewing conditions of the broadcast contents 510 recorded and reproduced by the user as a user history information, and then reads the user's taste or preference and viewing tendency therefrom to extract the broadcast contents accordingly. This saves the user's time and effort for inputting, for example, the type of the broadcast content 510 as the viewing condition 210.

The list of viewable broadcast contents 310 can be created by analyzing the broadcast content information. For example, the broadcast content information of the respective broadcast contents 510 stored in the storage unit 500 is analyzed, and the list of viewable broadcast contents 310 is created so that airdates, airtimes, and recording dates and times of the broadcast contents 510 are listed in the order of older dates. Then, the broadcast contents 510 which should be viewed in a certain order for the user to understand the storyline of the whole contents can be rearranged so that the user can view the broadcast contents 510 in a correct viewing order (for example, in such an order that the user can view the contents with older recording dates).

The list of viewable broadcast contents 310 includes the broadcast content information included in the recorded broadcast contents 510, required viewing time, reproduction rate, and a pointer to the files. The pointer to the files may be a pointer directly to the files per se of the broadcast contents or a pointer to the files of the broadcast contents 510 converted at the most suitable reproduction rate.

The timing of creating the list of viewable broadcast contents 310 is set as described below. The list of viewable broadcast contents 310 may be created when the reception unit 400 receives the broadcast content 510 or the reproduction unit 300 reproduces the broadcast content 510, or when the user inputs the viewing condition 210 to the input unit 200 or immediately after the reproduction rate of the broadcast content 510 is analyzed. When the timing is thus automatically decided, it is unnecessary for the user to beware of the timing. The list of viewable broadcast contents 310 may recite the broadcast contents 510 in the order of their titles, based on the user's preference or taste, time wise, or by types of the broadcast contents 510.

FIG. 16 is a flow chart of steps of the reproduction processing. The reproduction unit 300 can adjust the reproduction rate based on the reproduction rate distribution information 513 and reproduce the broadcast content 510 at the reproduction rate thus adjusted. This eliminates the need to create the files of the broadcast content 510 after the reproduction rate thereof is converted, thereby avoiding increase of the storage volume for recording on the recording medium. When, for example, the user selects any combination of the broadcast contents 510 which the user wants to view from the list of viewable broadcast contents 310 (S3100), the reproduction unit 300 refers to the reproduction rate distribution information 513 of the relevant broadcast content 510 from the broadcast contents 510 stored in the storage unit 500 (S3200), and reproduces the relevant broadcast content 510 while adjusting the reproduction rate thereof based on the information referred to (S3300). Then, the user can view the broadcast content 510 which complies with the viewing condition 210.

In the description given so far, the list of viewable broadcast contents 310 is created, and a combination of the broadcast contents 510 which the user wants to view is selected from the list of viewable broadcast contents 310. Another option is to automatically produce a combination of the most suitable broadcast contents 510 recommended by the recording and reproducing system 100 from the user history information such as his viewing history, thereby saving the user's time and effort for choosing and combining the broadcast contents 510.

The reproduction unit 300 can reproduce the broadcast content 510 after the reproduction rate thereof is converted using the reproduction rate distribution information 513. Accordingly, the files of the broadcast content 510 converted at the most suitable reproduction rate can be created and stored in the storage unit 500, so that the processing load of the reproduction unit 300 during the reproduction is alleviated.

The broadcast content 510 after the reproduction rate thereof is converted can be reproduced on various mobile terminals such as a mobile telephone. The broadcast content 510 maybe recorded and the reproduction rate thereof is converted in the recording and reproducing system in the user's home, and the files of the broadcast content 510 after the reproduction rate thereof is converted are transmitted to and stored in a mobile reproduction device (for example, mobile telephone). Then, the user can view the files on the mobile reproduction device, for example, in a vehicle on his way to work or school, thus flexibly using any reproduction device suitable for his lifestyle.

As described so far, the present exemplary embodiment accomplishes the reproduction of the broadcast content 510 suitable for a user's convenience at any desired reproduction rate, thereby allowing the user to view the broadcast content 510 in a time-efficient manner with less time than an actual recording time in total. Further, the exemplary embodiment makes it unnecessary to divide the broadcast content 510 as in the conventional manner, thereby helping the user view the broadcast content without a break in continuity of the content.

### INDUSTRIAL APPLICABILITY

The recording and reproducing system according to the present invention reproduces a broadcast content of a user's choice at any reproduction rate desired by the user, thereby helping the user view the broadcast content without a break in continuity of the content. The recording and reproducing system is a very advantageous system for recording and reproducing a broadcast content.

### DESCRIPTION OF THE REFERENCE SYMBOLS

100 recording and reproducing system
200 input unit
210 viewing condition
211 time information indicating a timing of starting to generate reproduction rate distribution information
300 reproduction unit
310 list of viewable broadcast contents
400 reception unit
500 storage unit
510 broadcast content
511 sound information
512 video information
513 reproduction rate distribution information

What is claimed is:

1. A system for recording and reproducing a received broadcast content, comprising
an input unit for receiving a viewing condition inputted by a user for the broadcast content; and
a reproduction unit for reproducing the broadcast content which meets the viewing condition received by the input unit while controlling a reproduction rate indicating a reproduction speed of the broadcast content.

2. The system for recording and reproducing a broadcast content as claimed in claim 1, further comprising:
a reception unit for receiving the broadcast content; and
a storage unit for storing therein the broadcast content received by the reception unit, wherein
the reproduction unit reads the broadcast content which meets the viewing condition from the storage unit and reproduces the read broadcast content.

3. The system for recording and reproducing a broadcast content as claimed in claim 1, wherein
the reproduction unit controls the reproduction rate based on a distribution information of the reproduction rate on a time axis in the broadcast content.

4. The system for recording and reproducing a broadcast content as claimed in claim 1, wherein
the reproduction unit analyzes the broadcast content and generates the distribution information based on an analysis result thereby obtained.

5. The system for recording and reproducing a broadcast content as claimed in claim 2, wherein
the reproduction unit analyzes the broadcast content and generates a distribution information of the reproduction rate on a time axis in the broadcast content based on an analysis result thereby obtained, and
the reproduction unit stores the generated distribution information in the storage unit, and
the reproduction unit reads the distribution information from the storage unit when the reproduction rate is controlled and controls the reproduction rate based on the read distribution information.

6. The system for recording and reproducing a broadcast content as claimed in claim 3, wherein
the distribution information is already appended to the broadcast content.

7. The system for recording and reproducing a broadcast content as claimed in claim 1, wherein
the viewing condition received by the input unit includes a condition relating to an amount of time available for the user to view the broadcast content.

8. The system for recording and reproducing a broadcast content as claimed in claim 1, wherein
the viewing condition received by the input unit includes a condition relating to a time point or a duration of time when the user is available for viewing the broadcast content.

9. The system for recording and reproducing a broadcast content as claimed in claim 3, wherein
the reproduction unit analyzes at least one of an audio data and a video data included in the broadcast content and generates the distribution information based on an analysis result thereby obtained.

10. The system for recording and reproducing a broadcast content as claimed in claim 3, wherein
the reproduction unit analyzes a sound volume of an audio data included in the broadcast content and generates the distribution information based on an analysis result thereby obtained.

11. The system for recording and reproducing a broadcast content as claimed in claim 3, wherein
the reproduction unit analyzes all of the broadcast contents and generates the distribution information based on an analysis result thereby obtained.

12. The system for recording and reproducing a broadcast content as claimed in claim 3, wherein
the reproduction unit generates the distribution information based on an information indicating details of the broadcast content appended to the broadcast content.

13. The system for recording and reproducing a broadcast content as claimed in claim 3, wherein
the reproduction unit samples the broadcast content and generates the distribution information based on a sampling result thereby obtained.

14. The system for recording and reproducing a broadcast content as claimed in claim 3, wherein
the reproduction unit generates the distribution information by a timing of receiving the broadcast content.

15. The system for recording and reproducing a broadcast content as claimed in claim 3, wherein
the reproduction unit generates the distribution information by a timing of reproducing the broadcast content.

16. The system for recording and reproducing a broadcast content as claimed in claim 3, wherein
the reproduction unit decides a timing of generating the distribution information based on a time information indicating a timing of starting to generate the distribution information included in the viewing condition received by the input unit.

17. The system for recording and reproducing a broadcast content as claimed in claim 3, wherein
an operation of the reproduction unit is controlled by an operating system (OS), and the reproduction unit decides a timing of generating the distribution information based on an operational state of the operating system (OS).

18. The system for recording and reproducing a broadcast content as claimed in claim 3, wherein
the reproduction unit decides a timing of generating the distribution information based on a hardware (H/W) state of the reproduction unit.

19. The system for recording and reproducing a broadcast content as claimed in claim 3, wherein
the distribution information includes a sound volume distribution information and the reproduction rate distribution information on a time axis in the broadcast content.

20. The system for recording and reproducing a broadcast content as claimed in claim 3, wherein
the distribution information includes a required viewing time information of the broadcast content after the reproduction rate is converted.

21. The system for recording and reproducing a broadcast content as claimed in claim 3, wherein
the distribution information includes the broadcast content after the reproduction rate is converted.

22. The system for recording and reproducing a broadcast content as claimed in claim 3, wherein
the reproduction unit generates a list of viewable broadcast contents.

23. The system for recording and reproducing a broadcast content as claimed in claim 22, wherein
the reproduction unit generates the list of viewable broadcast contents based on a reproduction history information of the broadcast contents.

24. The system for recording and reproducing a broadcast content as claimed in claim 22, wherein
the reproduction unit generates the list of viewable broadcast contents based on the viewing condition.

25. The system for recording and reproducing a broadcast content as claimed in claim 22, wherein
the reproduction unit generates the list of viewable broadcast contents based on based on an information indicating details of the broadcast content appended to the broadcast content.

26. The system for recording and reproducing a broadcast content as claimed in claim 22, wherein
the list of viewable broadcast contents includes a broadcast content information included in the broadcast content, a required viewing time, the reproduction rate, and a pointer to files.

27. The system for recording and reproducing a broadcast content as claimed in claim 3, wherein
the reproduction unit reproduces the broadcast content after the reproduction rate is converted based on the distribution information.

28. The system for recording and reproducing a broadcast content as claimed in claim 3, wherein
the reproduction unit reproduces the broadcast content while adjusting the reproduction rate on a time axis based on the reproduction rate distribution information.
